(19) United States
(12) Patent Application Publication
(10) Pub. No.: US 2021/0325090 A1
(43) Pub. Date: Oct. 21, 2021

(54) METHOD AND DEVICE FOR OBTAINING USEFUL ENERGY FROM GEOTHERMAL HEAT

(71) Applicant: Climasolutions GmbH, Ahrensbök (DE)

(72) Inventor: Uwe PFÜTZE-RÄMSCH, Ahrensbök (DE)

(73) Assignee: Climasolutions GmbH, Ahrensbök (DE)

(21) Appl. No.: 17/270,085

(22) PCT Filed: Aug. 21, 2019
(86) PCT No.: PCT/EP2019/072331

§ 371 Date: Feb. 22, 2021

(30) Foreign Application Priority Data
Aug. 24, 2018 (EP) 18190739.5

(51) Int. Cl. F24T 10/17

(52) U.S. Cl. CPC F24T 10/17

(57) ABSTRACT

A method for obtaining useful energy from geothermal heat. A coaxial tube is provided which includes an inner and outer tube connected to together in an end section of the coaxial tube. The coaxial tube is introduced into a deep bore in the earth and a thermal medium liquid under standard conditions is introduced into the outer tube and flows in the direction of the end section of the coaxial tube. The thermal medium is heated while absorbing geothermal heat, passes through a phase transition in the region of the end section, passes over in gaseous form into the inner tube, and flows upward therein up to an upper end of the coaxial tube located at the Earth's surface. A flow generator for generating electric energy is operated using the flowing, gaseous thermal medium and the kinetic energy of the flowing gaseous thermal medium is converted to obtain usable energy.

### TECHNICAL FIELD

The present invention relates to a method and a device for obtaining useful energy from geothermal heat.

### BACKGROUND

### Background Information

Using geothermal heat to obtain energy has been known for some time. The first geothermal power plant used for obtaining electrical energy was already put into operation at the beginning of the 20th century. There are also efforts presently, not least against the background of a search for climate-neutral and CO₂-emission-free forms of obtaining energy, of making geothermal heat usable better and more extensively in geothermal applications for obtaining energy.

In particular, there are geothermal devices and methods for generating heat and/or electric energy by means of surface geothermal energy (at depths down to 400 m) or deep geothermal energy (at depths of greater than 400 m). In the known methods, water is geothermally heated down to great depths. The heated water, also called thermal water, is transported to the Earth's surface and the geothermal heat absorbed by the water is then utilized to obtain useful energy.

In deep geothermal energy, a differentiation is made between hydrothermal and petrothermal systems. In the hydrothermal systems, water stored in low-lying layers is extracted and conveyed to the surface and its stored heat is used to obtain energy. In petrothermal systems, geothermal heat stored in plutonic rock is absorbed using water conveyed therein and brought into heat exchange with the plutonic rock and the water thus heated is conveyed to the surface to obtain energy there. In the hydrothermal systems, open systems are thus formed, in which material (water) located at great depths is removed and in exchange a replacement is generally conducted from the Earth's surface there and stored. The removed water can also be returned to the depths. The risk of introducing contamination into the water from the great depths thus exists here in particular. Petrothermal systems can also be implemented using geothermal heat probes, in which the water is conducted in a closed circuit, and which absorb the geothermal heat stored in the plutonic rock through a wall of the geothermal heat probe.

In addition to the problem that is given in the case of hydrothermal systems, namely the possible introduction of impurities and contaminants into the low-lying reservoir of the thermal water, the known systems furthermore have the disadvantage that in general only a low efficiency can be achieved in particular for generating electrical energy. To use the water utilized in the known systems as a thermal medium to drive an electric generator machine, the water has to reach the surface at a temperature of at least 80° C. The water can only be used directly to drive, for example a steam turbine, if it exits at the surface in the form of steam. This can either be achieved only using bores driven to great depths (on average the temperature increases by 3° C. with 100 m depth, so that temperatures of 100° C. are only encountered at very great depths in normal conditions) or with bores in the region of special conditions, in which particularly high temperatures are also already to be encountered at lesser depths, for example due to volcanic activities or special anomalies of the Earth's magnetism.

### SUMMARY

Remedies are to be provided here by the invention and a method and a device are to be specified, using which geothermal electrical energy can also be generated in normal conditions and lesser bore depth.

This problem is solved and the intended goal is first achieved by a method for obtaining useful energy from geothermal heat wherein in a coaxial tube introduced into a deep bore in the earth, which includes an outer tube and an inner tube, in which outer tube and inner tube have a connection to one another in an end section of the coaxial tube sunk in the deep bore, a thermal medium liquid under standard conditions is introduced into the outer tube and flows in the direction of the end section of the coaxial tube sunk in the deep bore, wherein the thermal medium is heated while absorbing geothermal heat and passes through a phase transition in the region of the end section and passes over in gaseous form into the inner tube and flows upward therein up to an upper end of the coaxial tube located at the Earth's surface, and wherein a flow generator for generating electric energy is operated using the flowing, gaseous thermal medium.

Advantageous refinements of a method according to the invention include that the thermal medium may be guided through a heat exchanger after flowing through the flow generator to obtain usable thermal energy. The thermal medium may be liquefied after flowing through the flow generator and may be introduced in liquid form again into the outer tube of the coaxial tube. The thermal medium may be guided in the outer tube on a spiral-shaped path in the direction of the end section sunk in the deep bore. The thermal medium may accumulate in the outer tube in at least one section of the outer tube, in particular in multiple such sections, due to barriers, for example plate-like barriers, introduced into the outer tube and may be transferred via nozzle openings, which may be formed in the barriers and lead into a vertically lower-lying section of the outer tube, with expansion into the vertically lower-lying section. The method may further comprise driving a deep bore into the earth and introducing the coaxial tube into the deep bore. The deep bore may be introduced into a depth of at least 1000 m. The deep bore may be introduced to a depth of at most 2500 m.

Furthermore, a method for obtaining useful energy from geothermal heat may include dodecafluoro-2-methylpentane-3-1 being used as the thermal medium is proposed by the invention as a solution to the above problem. Advantageous refinements of a device according to the invention include a coaxial tube introduced into a deep bore, wherein the coaxial tube may include an outer tube and an inner tube and wherein outer tube and inner tube may have a connection to one another in an end section of the coaxial tube sunk in the deep bore; guide structures, in particular spiral guide plates or, for example plate-shaped barriers penetrated with nozzle openings, may be arranged in the outer tube and protruding through its cross section; a supply line may be connected to an inlet opening of the outer tube provided at an end of the coaxial tube axially opposite to the end section; a gas flow channel may be connected to an outlet opening of the inner tube provided at the end of the coaxial tube; a flow generator may be arranged in the gas flow channel for generating electric energy; and a thermal medium arranged to flow through the coaxial tube, which may be liquid under standard conditions and has a boiling point at normal pressure of between 30° C. and 120° C. The thermal medium may have a boiling point at normal pressure of between 30° C. and 60° C. A section of the inner tube may be arranged at the end of the coaxial tube, in which a diameter of the inner tube is widened starting from a first diameter, which the inner tube has along its extension up to an end section, up to a second diameter, which the outlet opening has. A flow guide having a diameter widening may be arranged after a flow turbine of the flow generator seen in the through flow direction. A heat exchanger which may be arranged on a side of the flow generator opposite to the gas flow channel connecting the outlet opening to the flow generator and may be connected to the flow generator using a flow line, for obtaining usable thermal energy. The outlet opening and the inlet opening may be connected to one another in a closed line system.

In the method according to the invention, a coaxial tube is introduced into the earth and inserted into a deep bore. The introduction of the deep bore and the insertion of the coaxial tube into the deep bore can be steps included in the method. However, the method can also be carried out without the steps, i.e., following and detached from a separately performed introduction of the bore and insertion of the coaxial tube. The coaxial tube has an outer tube and an inner tube and is sunk with an end section into the deep bore, and typically extends with this end section down to the base of the deep bore. In the region of this end section, the outer tube and the inner tube of the coaxial tube are fluidically connected to one another, i.e., a medium conducted in the outer tube passes over there into the inner tube. When the method is carried out, a thermal medium liquid under standard conditions (SATP conditions) is introduced into the outer tube and flows in the direction of the end section of the coaxial tube sunk in the deep bore. The standard conditions are defined by the International Union of Pure and Applied Chemistry (IUPAC) as a temperature of 25° C. and a pressure of 1000 mbar at the same time. This pressure of 1000 mbar is also referred to hereinafter in this application as normal pressure.

The thermal medium then flows in the direction of the end section of the coaxial tube, which can take place in particular exclusively driven by gravity. The thermal medium absorbs geothermal heat and is thus heated. Additional heating can also be take place here due to friction of the thermal medium flowing along a wall of the outer tube. However, the significant heat absorption is effectuated by the geothermal heat. In a section of the coaxial tube located in the last third of the coaxial tube, a phase transition of the thermal medium then takes place, which passes over into the gas phase in this region and enters the inner tube in gaseous form in the region of the end section. Gaseous thermal medium now rises in the inner tube and flows upward. The flowing, gaseous thermal medium is then guided to a flow generator, which is operated to generate electrical energy driven by this gas flow.

The thermal medium can be water, for example. However, it can also in particular be a thermal medium different from water, for example one which has a significantly lower boiling point than water at normal pressure. The boiling point of such an alternative thermal medium at normal pressure can be in particular in a range between 30° C. and 60° C.

A chimney effect can be used for the rising of the thermal medium in the inner tube. This can occur in particular in that the inner tube has a diameter expansion in the region of an outlet at or in the region of the Earth's surface, by which at this point an expansion and reduction of the temperature of the outflowing gas is achieved in comparison to a temperature of the gaseous thermal medium located in the region of the end section, in particular at a lower end of the inner tube.

In the method according to the invention, thermal energy absorbed and stored in the thermal medium is thus not predominantly used, but rather kinetic energy of the gas flow obtained during the rising of the gaseous thermal medium in the inner tube, which is used to drive the flow generator. With suitable design of the method parameters, significant flow velocities, velocities of significantly greater than 200 km/h, can be obtained here, using which correspondingly designed flow generators, which can be dimensioned very small in their measurements, can be driven. In particular, it is also possible to divide the gas flow into various partial flows, in order to thus operate more than one flow generator in parallel.

The inner tube can have an anti-adhesive structure on its internal surface, for example in the form of a coating, for example a structure displaying the so-called lotus effect.

Adhesion of particles entrained in the gas flow which rises in the inner tube or the like is thus prevented, so that the inner tube remains free in its diameter. This coating can also have a friction-reducing effect, so that the velocity of the gas rising in the inner tube is not reduced. For such a reduction of the friction, the inner tube can also have another suitable structure, for example in the form of a coating, on the internal surface.

For a further utilization of the energy that is entrained by the flowing gaseous thermal medium and absorbed in particular from the geothermal heat, it can be provided that the thermal medium is also guided through a heat exchanger after flowing through the flow generator, in order to thus obtain usable thermal energy. The overall efficiency of the method increases due to such a combination.

After flowing through the flow generator (and possibly after flowing through the heat exchanger), the thermal medium can advantageously be liquefied and introduced in liquid form again into the outer tube of the coaxial tube. In this variant, the method is operated using a thermal medium guided in a closed circuit, so that new thermal medium does not have to be continuously supplied, for example.

The thermal medium can advantageously be guided in the outer tube on a spiral-shaped path in the direction of the end section sunk in the deep bore. This can take place, for example, in that corresponding guide structures are provided in the outer tube, for example guide plates guided in spiral form, for example installed, for example welded, on an outer wall of the inner tube. Guiding the thermal medium in such a spiral shape has various advantages. The thermal medium accelerated in this case in the direction of the end section is thus pressed outward in the outer tube, in the direction of the outer wall, by a spiral-shaped path, so that it is in particularly good contact there with the outer wall and can effectively absorb the geothermal heat entering via this wall. Moreover, friction arises between the wall of the outer tube and the thermal medium in the case of such guiding, which can result in additional heating of the thermal medium and can thus contribute to an introduction of heat. Corresponding guide structures which divide the outer tube of the coaxial tube similarly into individual height sections, also prevent in any case in the dynamic case, in which the thermal medium does not stand in the outer tube but rather flows in corresponding compartments or sections without the outer tube being completely filled a high dynamic pressure from prevailing in the end section of the coaxial tube, which could prevent a phase transition into the gas phase of the thermal medium even at the temperatures of the thermal medium achieved due to the absorbed heat, which are above the boiling point of the thermal medium under standard conditions.

Alternatively and also advantageously, however, the thermal medium can also be accumulated in the outer tube in at least one section of the outer tube, in particular in multiple such sections, by barriers introduced into the outer tube, for example plate-like barriers, and can be transferred via nozzle openings contained in the barriers and leading into a section of the outer tube located vertically deeper with expansion into the section located vertically deeper. This procedure has the advantage that depending on the amount of the thermal medium poured into the outer tube, a water column arises on the, for example plate-shaped barriers quickly, slowly, or constantly. A static pressure thus results on the barrier in each section, which can be set via the feed rate of the thermal medium and the opening cross sections of the nozzle openings, for example to 10 bar. This static pressure prevents a phase transition which is too early for the operation of the method of the thermal medium in this section. In a section located vertically below the barrier, an expansion results due to the thermal medium flowing with pressure through the nozzle openings, which results in cooling of the thermal medium and thus an increase of the temperature difference between thermal medium and tube wall. The tube wall is thus also cooled, whereby the thermal conductivity of the rock is in turn increased. This results from the law of entropy of thermodynamics, the second law of thermodynamics. Due to the increase of the thermal conductivity of the rock, an increase of the temperature conductivity also results, which has the consequence that thermal energy flows faster from a greater distance to the outer tube of the coaxial tube. The cooled thermal medium then falls in the section located vertically below the nozzle openings at a high velocity, which can be, for example at least 70 m/s, down to a further column made up of thermal medium located underneath which has accumulated due to a further possible barrier, and which is loaded on the possible further barrier. The thermal medium thus, in spite of a temperature of the rock, which is above the phase change temperature at normal pressure, cannot vaporize, because the static pressure of the loading column of the thermal medium prevents this. It can be at least 5 bar, for example. At a barrier located lowermost in the outer tube, the nozzle openings are then dimensioned and arranged so that the temperature of the thermal medium no longer passes below the phase change limit with cooling, but the geothermal expansion effect can still be used.

The distance between the barriers and/or the opening cross section of the nozzle openings are determined in dependence on which geothermal conditions are to be encountered at the usage location of the coaxial tube. Efforts can be made in particular to define these values so that due to the expansion achieved by means of the barriers and nozzle openings, a temperature difference between the temperature of the surrounding layers of earth (the rock) at the respective depth and the temperature of the tube wall of the outer tube is between 20 K and 25 K.

In principle, it is also conceivable here to change the opening cross sections of the nozzle openings during operation for the control of the plant. This can be carried out, for example, by means of remote-controlled adjustable nozzle openings (like an aperture) or also by introducing inserts decreasing the opening cross sections into the nozzle openings (or removing such inserts from the nozzle openings), which can be carried out, for example with the aid of small robots arranged in the outer tube and controllable by means of a controller.

The depth of the deep bore is in particular at least 1000 m, advantageously at least 1300 m, in particular at least 1500 m, and can furthermore in particular be at a greatest depth of 6000 m, but can depending on the temperature required for the process, which is also dependent on the selected thermal medium also be at most 2500 m, in particular at most 2000 m. At corresponding depth, temperatures of approximately 40° C. to 78° C. (at depths down to 2500 m) prevail in typical geological conditions if one proceeds from the rule of thumb of heating of 3° C. per 100 m and 6° C. for the first 100 m. If depths down to 6000 m are selected, temperatures of greater than 130° C. can be obtained there. As mentioned at the outset, temperatures of 48° C. to 78° C. are not yet sufficient to operate an electric generator using the water employed in typical methods. Using a suitable thermal medium, which has a boiling temperature in the range between 30° C. and 60° C. under standard conditions, the above-described effect can be achieved and the above-described method can be operated even with bores driven to lesser depths. In particular dodecafluoro-2-methylpentane-3-1 can be used as a thermal medium used as an alternative to water. This is a liquid which is colorless and odorless under standard conditions and which is sold, for example by 3M under the tradename Novec®, for example as Novec® 649. However, as already mentioned, water can also be used as a thermal medium, wherein higher temperatures, and thus bores sunk deeper, are then required.

Although a greatest depth of the deep bore is mentioned above and is specified, for example as 6000 m, it is readily conceivable to also drive the deep bore into even greater depths, for example down to 10,000 m, and insert a coaxial tube according to the invention in a deep bore of corresponding depth. However, since the costs of a deep bore increase significantly and in particular also not linearly with greater depth, lesser depths of the deep bore are preferred if suitable geothermal conditions for the method are found accordingly in the layers bored to.

A device according to the invention for obtaining energy from geothermal heat includes the following elements:
A coaxial tube introduced into a deep bore. This coaxial tube includes an outer tube and an inner tube, wherein outer tube and inner tube have a connection to one another in an end section of the coaxial tube sunk in the deep bore. The coaxial tube is typically guided with the end section down to a base of the deep bore.
guide structures arranged in the outer tube and protruding through its cross section, in particular spiral guide plates or barriers penetrated by nozzle openings and formed plate-shaped, for example;
a supply line connected to an inlet opening of the outer tube, which is provided at an end of the coaxial tube axially opposite to the end section;
a gas flow channel connected to an outlet opening of the inner tube, which is provided at the end of the coaxial tube;
a flow generator arranged in the gas flow channel for generating electrical energy. The flow generator is arranged here in the gas flow channel in such a way that a rotor of the generator is moved by inflowing gas to drive the generator;
a thermal medium arranged to flow through the coaxial tube, which is liquid under standard conditions and has a boiling point at normal pressure (i.e., 1000 mbar) of between 30° C. and 120° C., for example of between 30° C. and 60° C.

A method as described above can be carried out using this device according to the invention. The two examples of guide structures specified as examples, i.e., spiral guide plates, on the one hand, or barriers provided with nozzle openings, for example plate-like barriers, which can also be referred to as expansion plates, result in the advantages described above in conjunction with the method.

In the device, in particular a section of the inner tube arranged at the end of the coaxial tube can have a diameter expansion. A diameter of the inner tube is expanded there starting from a first diameter, which the inner tube has along its extension up to the end section, to a second diameter, which the outlet opening has. A chimney effect desired during operation of the device is strengthened by this measure, by which the gaseous thermal medium flowing upward therein is drawn upward, in the direction of the end of the coaxial tube located at the Earth's surface.

The chimney effect, in particular for the startup of the plant or the device, but also in operation, can also be influenced by a setting of a temperature difference, to thus assist the regulation of the plant. For this purpose, a device for controlled heating and/or cooling of the wall of the inner tube can be provided, in particular in the upper end section of the inner tube.

The device according to the invention can furthermore include a flow guide having a diameter expansion after the flow generator seen in the through-flow direction. It can act as a diffuser and achieve a reduction of the flow velocity of the thermal medium.

The device can furthermore additionally include a heat exchanger, which is arranged beyond the flow generator, i.e., on the side which is located opposite to the outlet opening having the flow channel connected to the flow generator. Usable thermal energy can then be obtained using such a heat exchanger. If a flow guide having a diameter expansion is provided after the flow generator seen in the through-flow direction, as mentioned above, it is thus advantageously before the inflow opening of the heat exchanger, so that the thermal medium flows through the heat exchanger at reduced velocity.

The outlet opening and the inlet opening are advantageously connected to one another in a closed line system in the device, so that overall a closed circuit is obtained, in which the thermal medium can circulate. In particular a degassing and storage container can be arranged in such a closed circuit, into which the thermal medium flowing through the flow generator flows after liquefying, which can take place due to expansion and cooling, and from which the thermal medium thus liquefied can be conveyed back in the direction of the inlet opening of the outer tube and introduced there back into the circuit.

One or more valve(s) can advantageously be provided in the device, which can be arranged in particular in the supply line and/or the gas flow channel for deliberately opening and/or closing the supply line and/or the gas flow channel and which are connected to a controller for automatically actuating the at least one valve. A control of the device can be carried out via such valves, which can also be flow rate control valves for deliberately setting a flow rate. This is because it is essential for the operation of the device that the thermal medium flows through the coaxial tube in a dynamic process. In particular, only enough further liquid thermal medium always has to be added as vaporizes in the end section of the coaxial tube and rises through the inner tube. If too much thermal medium is added, the risk thus exists that the entire outer tube will be filled with (still liquid) thermal medium and the process of the phase transition in the end section of the coaxial tube will be suppressed by the hydrostatic pressure then resulting, and the system will come to a standstill. Accordingly, it thus has to be ensured via a controller that the dynamic process is maintained. To be able to monitor and control this process, responsive sensors can also be provided, which detect characteristic values of the method, for example pressure and temperature of the outflowing gaseous thermal medium or a volume flow of the thermal medium and provide them as input variables for the process guidance of the controller.

The thermal medium used in the device mentioned in the invention can in particular be dodecafluoro-2-methylpentane-3-1, but can also be water, for example.

### BRIEF DESCRIPTION OF THE SEVERAL VIEWS OF THE DRAWINGS

Further advantages and features of the invention result from the following description of an exemplary embodiment on the basis of the appended figures. In the figures:

FIG. 1 shows a schematic sketch of a device according to the invention and illustrates the method according to the invention in a first possible embodiment;

FIG. 2 shows a schematic sketch of a device according to the invention and illustrates the method according to the invention in a second possible embodiment;

FIG. 3 shows an enlarged, schematic sectional illustration of the coaxial tube of the embodiment shown in FIG. 2; and

FIG. 4 schematically shows a top view of an expansion plate including nozzle openings of the embodiment according to FIG. 2.

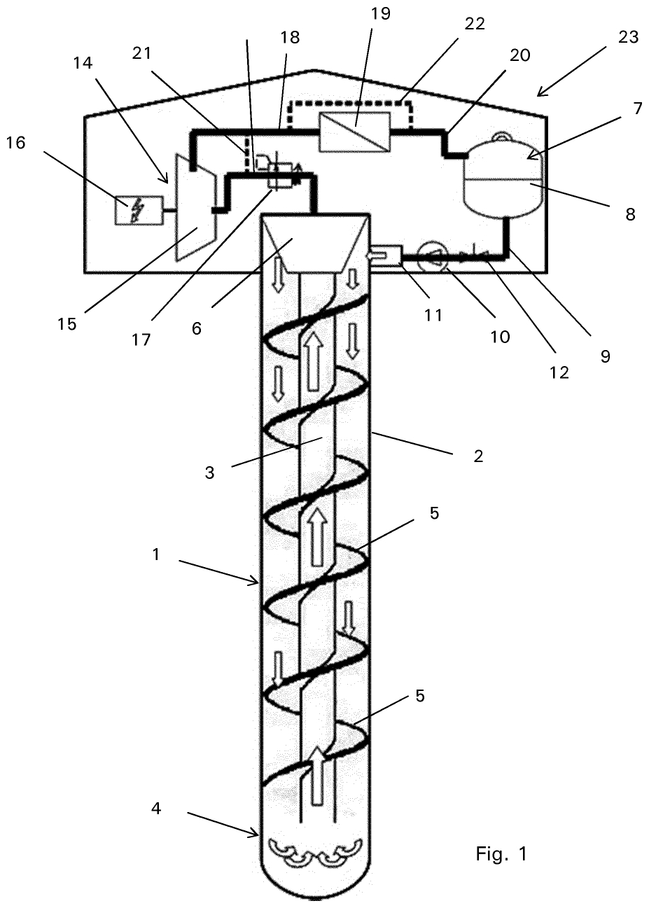

FIG. 1 very schematically shows a sketch of a first possible embodiment of the invention, which also schematically explains the method according to the invention in a first embodiment variant.

### DETAILED DESCRIPTION

A coaxial tube 1 is introduced into a borehole of a deep bore (not shown in greater detail here). It is closed at an end inserted into the borehole and consists of an outer tube 2 and an inner tube 3. The inner tube 3 is shorter than the outer tube 2, so that the outer tube 2 is connected to the inner tube 3 in an end section 4.

The depth of the bore into which the coaxial tube 1 is inserted, and thus also the length of the coaxial tube 1, can in particular be between 1000 m and at most 6000 m, for example also at most 2500 m, and in the exemplary embodiment shown is in particular approximately 1600 m.

The outer tube 2 can be thermally insulated in relation to the inner tube 3 down to a depth of approximately 1000 m. Guide plates 5 (which can also be formed as a continuous guide plate) are fixed on the inner tube 2, which extend into the passage of the outer tube 2 and up to its outer wall and turn in the form of a spiral or helix in the direction of the end section 4.

The inner tube 3 opens at the end of the coaxial tube 1 opposite to the end sunk into the borehole with an expansion 6.

A thermal medium 8, which is liquid under standard conditions, is stored in a degassing and storage container 7. It is in liquid phase in the degassing and storage container 7. Liquid thermal medium 8 is continuously introduced into the outer tube through a line 9 by means of a pump 10 and via an inlet 11. The thermal medium can be, for example dodecafluoro-2-methylpentane-3-1, for example the fluid sold by 3M under the tradename Novec® 649. This thermal medium has, for example a boiling point under standard conditions of 49° C. However, water or another fluid can also be used as the thermal medium.

A valve 11 is provided in the line 9, using which the line 9 can be closed and using which furthermore the flow rate of the thermal medium 8 through the line 9 can be controlled.

The thermal medium 8 flows in a rotating movement in the outer tube 2 downward in the direction of the end section 4 through the turns of the guide plates 5, which can, for example be welded onto the outer wall of the inner tube 3. Due to the increasing velocity at which the thermal medium 8 flows downward and due to the active centrifugal force, the thermal medium 8, the farther down it moves, is pressed with greater and greater force against the outer wall of the outer tube 2. The thermal medium 8 absorbs geothermal thermal energy, wherein this takes place particularly effectively due to the pressing of the thermal medium 8 against the outer wall of the outer tube 2. In addition, further heat results due to the friction of the thermal medium 8 on the inner side of the outer wall of the outer tube 2, which additionally causes the temperature of the thermal medium 8 to increase.

The guide plates 5 guided in spiral-shaped turns are provided up to point at which a phase transition threshold begins. This is a point in the depth of the bore at which the thermal medium 8 has heated up to the boiling point due to the above-described absorption of heat and now becomes gaseous. The lowermost section of the inner tube 3, for example the last 100 m, is not thermally insulated in relation to the outer tube 2, so that the guide plates 5 additionally represent heat transfer surfaces in this region. Since the hot gaseous thermal medium 8 rises upward in the inner tube 3, the inner tube 3 and the guide plates 5 also heat up and can thus also emit thermal energy.

If the thermal medium 8 reaches the thermal temperature range or the phase transition threshold, the thermal medium 8 begins to vaporize, as mentioned. Due to the continuous addition of thermal medium 8 into the outer tube 2 of the coaxial tube 1, more and more thermal medium 8 will implement the phase change. The gaseous thermal medium 8 then present in the end section 4 thus cannot rise upward in the outer tube 2. The guide plates also do not permit the gaseous thermal medium 8 to rise. The gaseous thermal medium 8 therefore rises in the inner tube 3, driven in particular by a negative pressure resulting due to an occurring chimney effect, upward in the direction of the upper end of the coaxial tube 1. It is expanded and cooled there in the region of the widening. Thus, no technical aids and no use of energy are required for the temperature reduction of the thermal medium 8, whereby the overall efficiency of the method would otherwise be worsened.

Due to the widening of the pipe diameter, the temperature difference between the lower end of the coaxial tube 1 sunk in the borehole and the highest point of the inner tube 3, in which the gaseous thermal medium 8 flows, becomes greater. This increases the chimney effect once again, which drives accelerated rising of the gaseous thermal medium 8 in the interior of the inner tube 3. The gaseous thermal medium 8 rapidly flowing upwards receives a high level of kinetic energy in this way. The expansion and temperature reduction of the gaseous thermal medium 8 in the widening is by corresponding design of the geometric conditions advantageously limited to 5 K above the boiling point of the thermal medium 8, so that it is still gaseous even after the expansion and a phase change back into the liquid phase does not occur until the kinetic energy of the thermal medium 8 has been used.

The flow velocity at which the gaseous thermal medium 8 flows upward, and thus its kinetic energy (mass×velocity) of the gaseous thermal medium 8, is dependent on the depth of the bore, on the temperature of the gaseous thermal medium 8, its density, and the temperature difference between the lower end of the coaxial tube 1 and the highest point of the inner tube 3 in which the gaseous thermal medium 8 flows.

The gaseous thermal medium 8 is transferred in the region of the widening in an outlet out of the inner tube 3 into a line 13 and conducted through it above ground to a flow generator 14, which operates similarly to a wind turbine. The flow generator 14 is composed of a flow turbine 15, against which the gaseous thermal medium 8 flows and which is set into rotation, and a generator 16, which is directly coupled to the flow turbine 15 and driven thereby, for generating electrical energy.

A valve 17 in the line 13 can be used to block and selectively open the line 13 and optionally also to set a flow rate through the line 13. For the startup of the system, the valve 17 is closed, so that due to the continuously refilled and vaporizing thermal medium 8, which rises in the inner tube 3, the pressure and the temperature continuously rise inside the coaxial tube 1 up to values required for the continuous operation of the device. If the required temperature and the pressure are reached, a controller automatically opens the valve 17. The temperature and the pressure are maintained by the continuous addition of the liquid thermal medium 8 by means of the pump 10, since the added thermal medium 8 continuously completes the phase change in the region of the phase transition threshold and thus resupplies gaseous thermal medium 8. This method is comparable to the mode of operation of a steam boiler having feed water continuously flowing in.

After flowing through the flow turbine 15, it is guided further in the line 18 to an optionally provided heat exchanger 19. The still contained thermal energy can be withdrawn from the gaseous thermal medium 8 there. This thermal energy can be used, for example for the district heat supply or for production heat supply. The cooled, still gaseous thermal medium 8 flows back via a further line 20 into the degassing and storage container 7. It completes the phase change from gaseous to liquid there. The degassing and storage container 7 can be cooled, for example using outside air. It is used for the phase change of the thermal medium 8 and is used at the same time as a storage container for the supply of the thermal medium 8 into the outer tube 2 of the coaxial tube 1. The circuit is thus closed.

If electric energy is not supposed to be generated, the flow turbine 15 and thus the flow generator 14 can already be bypassed via a short-circuit line 21, which is indicated by dashed lines and is switchable using valves (not shown in greater detail). In a similar way, a short-circuit line 22, which is also shown by dashed lines, can be activated by means of valves (not shown in greater detail) if thermal energy is not desired. The thermal medium 8 is then conducted directly from the flow turbine 15 into the degassing and storage container 8 while bypassing the heat exchanger 19.

An installation building, in which the technical devices are accommodated, is indicated by 23.

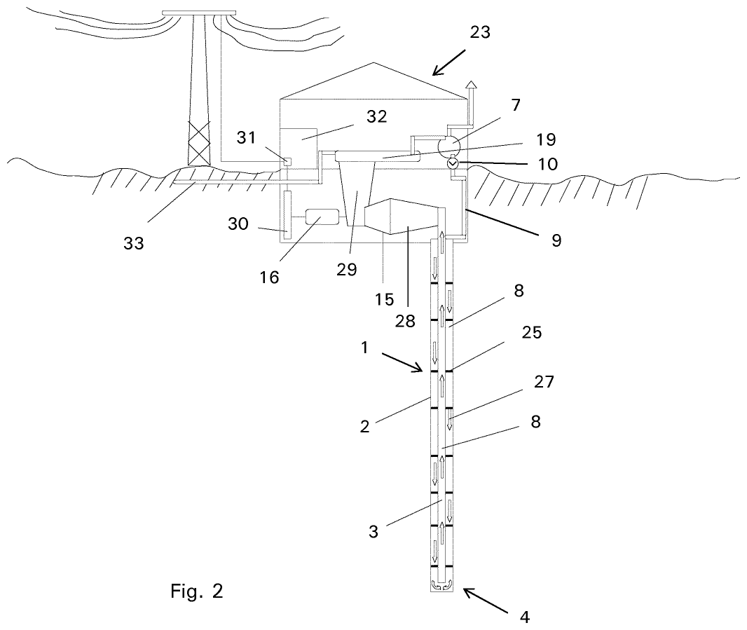

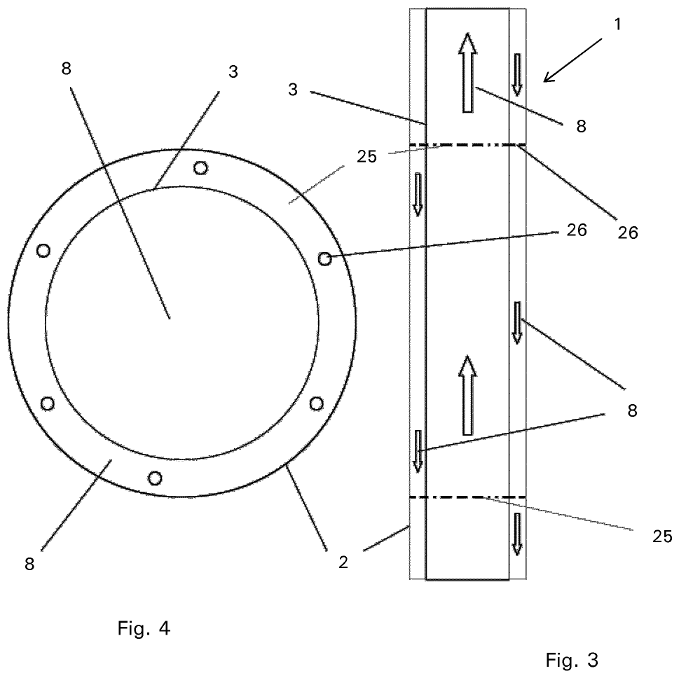

A sketch of a second possible embodiment of the invention is shown very schematically—in FIGS. 2 to 4, which also schematically explains the method according to the invention in a second embodiment variant. With respect to the basic principle, the device for making geothermal energy usable in the variant shown in FIGS. 2 to 4 is equivalent to the one illustrated in FIG. 1 and described above. In this regard, the same reference signs are also used in FIGS. 2 to 4 to identify the elements which are the same or have the same function.

The device shown in FIGS. 2 to 4 also contains a coaxial tube 1 sunk in a deep bore as a core part. The coaxial tube 1 is also closed at an end inserted into the borehole and consists of an outer tube 2 and an inner tube 3 in this embodiment. The inner tube 3 is also shorter than the outer tube 2 here, so that in an end section 4, the outer tube 2 is connected to the inner tube 3.

The depth of the bore is also measured in this exemplary embodiment as described above on the basis of the first exemplary embodiment and is in the same dimensions. It is also dependent on which temperatures are required for a phase transition to be obtained of the thermal medium used.

The outer tube 2 can also be insulated in this case over a first vertical section, which can be, for example approximately ⅔ of the total length of the outer tube 2, in relation to the inner tube 3.

In the exemplary embodiment shown in FIGS. 2 to 4, guide plates 5 in spiral-shaped or helix-shaped turns in the direction of the end section 4 are not fixed on the inner tube 2 as in the prior example, but rather barriers in the form of so-called expansion plates 25, in particular at regular intervals. Each of these expansion plates 25 closes off the entire cross section of the outer tube 2, but has passage nozzles 26, i.e., nozzle-shaped openings penetrating the expansion plates 25. These passage nozzles 26 can in particular be shaped tapering conically in the direction facing vertically upward. The expansion plates 25 thus divide the outer tube 2 into multiple sections arranged vertically one over another, which are fluidically connected via passage nozzles 25.

A thermal medium 8, which is liquid under standard conditions, is also stored in a degassing and storage container 7 in this exemplary embodiment. This thermal medium can again be water or also, for example dodecafluoro-2-methylpentane-3-1. It is provided in liquid phase in the degassing and storage container 7. Liquid thermal medium 8 is introduced continuously into the outer tube 2 by means of a pump 10 through a line 9. A valve (not shown here) can also be provided in the line 9 in the exemplary embodiment according to FIGS. 2 to 4, using which the line 9 can be closed and using which furthermore the flow rate of the thermal medium 8 through the line 9 can be controlled.

The thermal medium 8 poured into the outer tube 2 now first falls freely in a first section until it encounters the first expansion plate 25. The thermal medium 8 accumulates there, since the flow rate through the passage valves 26 is comparatively low. Due to the accumulation of the inflowing thermal medium 8, a standing column of the thermal medium 8 forms on the expansion plate 25, in which a static pressure builds up.

During the passage through the passage nozzles 26, expansion of the thermal medium 8 occurs, which then results in cooling. This has the result that the thermal medium 8 can in turn better absorb heat from the surroundings.

This accumulation and expansion of the thermal medium 8 at the expansion plates 25 or during the passage through the passage nozzles 26, respectively, now repeats in the lower region of each section or during the passage into the next lower section. The static pressure of the respective column of the thermal medium 8 loading the expansion plate 25 also prevents this thermal medium from passing through a phase transition into the gaseous phase early. The cooling effect obtained by the expansion during the passage of the thermal medium 8 through the passage nozzles 26 also prevents an early phase transition.

After passage through the passage nozzles 26 of the lowermost expansion plate 25 arranged in the outer tube 2, the thermal medium then reaches a phase transition threshold. The thermal medium 8 is thus finally heated by the absorption of heat as described above in the end section up to the boiling point given even under the conditions prevailing there (pressure, temperature) and now becomes gaseous. The lowermost section of the inner tube 3, for example the last third or also the last 100 m, can also not be thermally insulated in relation to the outer tube 2 here, so that the expansion plates 25 can represent additional heat transfer surfaces in this region. Since the hot gaseous thermal medium 8 rises upward in the inner tube 3, the inner tube 3 and the expansion plate 5 also heat up, and thus also can emit thermal energy.

The setting of the pressures required for continuous operation of the plant of the columns of the thermal medium 8 standing on the expansion plates 25 can be achieved by design of the number and opening cross sections of the nozzle openings 26, which can be selected differently for the expansion plates 25 on different levels, and via the supply rate of the thermal medium 8 fed into the outer tube 2.

If the thermal medium 8 reaches the thermal temperature range or the phase transition threshold, the thermal medium 8 also begins to vaporize in this design variant. Due to the continuous addition of thermal medium 8 into the outer tube 2 of the coaxial tube 1, on the one hand, and due to the barriers in the form of expansion plates only leaving the passage nozzles as a fluid connection, rising of the gaseous thermal medium 8 is prevented in the outer tube 2. Instead, more and more thermal medium 8 will also implement the phase change here. The gaseous thermal medium 8 in turn rises in the inner tube 3, driven in particular by a negative pressure resulting due to an occurring chimney effect, upward in the direction of the upper end of the coaxial tube 1. It is expanded and cooled there in the region of a diffuser 28, which is formed by a widening in the pipeline. Technical aids and the use of energy are thus not required here for the temperature reduction of the thermal medium 8, so that the overall efficiency of the method is also not worsened here.

The temperature difference between the lower end of the coaxial tube 1 sunk in the borehole and the highest point of the inner tube 3, in which the gaseous thermal medium 8 flows, again becomes greater due to the diffuser 28 and the cooling of the thermal medium thus achieved. This also once again increases the chimney effect here, which drives accelerated rising of the gaseous thermal medium 8 in the interior of the inner tube 3. In this way, the gaseous thermal medium 8 flowing rapidly upward also receives a high level of kinetic energy in this embodiment variant. The expansion and temperature reduction of the gaseous thermal medium 8 in the diffuser 28 is advantageously due to corresponding design of the geometric conditions also limited here to 5 K above the boiling point of the thermal medium 8, so that it is still gaseous even after the expansion and a phase change back into the liquid phase does not occur until the kinetic energy of the thermal medium 8 has been used.

The flow velocity at which the gaseous thermal medium 8 flows upward, and thus its kinetic energy (mass×velocity) of the gaseous thermal medium 8, is also dependent in this variant on the depth of the bore, on the temperature of the gaseous thermal medium 8, its density, and the temperature difference between the lower end of the coaxial tube 1 and the highest point of the inner tube 3, in which the gaseous thermal medium 8 flows.

The gaseous thermal medium 8 flowing out of the diffuser 28 flows against a flow turbine 15, which is set into rotation and drives a generator 16 for generating electric energy. This electric energy is transformed by means of a transformer 31, which is activated via a controller 30, to a voltage and is adapted using a possibly provided frequency converter to the network frequency of the power network, so that the electrical energy can then be fed into the power network.

After flowing through the flow turbine 15, the thermal medium is conducted to an optionally provided heat exchanger 19. The still contained thermal energy can be withdrawn there from the gaseous thermal medium 8. This thermal energy can then be used, for example for the district heat supply or local heat supply 33. The cooled, still gaseous thermal medium 8 then also flows here back into the degassing and storage container 7. It completes the phase change from gaseous to liquid there. The degassing and storage container 7 can be cooled, for example using outside air. It is used for the phase change of the thermal medium 8 and is used at the same time as a storage container for the supply of the thermal medium 8 into the outer tube 2 of the coaxial tube 1. The circuit is thus closed.

The plant technology is also largely housed here in an installation building 23, in which a control station 32 is also located, from which the plant can be controlled and operated.

The inventor has calculated here that for both embodiments only approximately 25 m² floor space of the installation building 23 are required for housing the technical devices required for the device, in order to implement a plant having a rated power of approximately 2.5 MW. A further advantage is the comparatively high density with which plants according to the invention can be implemented in area. The inventor has calculated here that again for plants of both embodiment variants a density of 4 plants per square kilometer is possible. This is significantly more than the case of conventional geothermal power plants, which have a much larger catchment area to the sides.

Special features and advantages of the method according to the invention and a device implementing this method are:
A coaxial tube is introduced into the depths.
A liquid thermal medium is introduced (for example pumped) into an outer tube of the coaxial tube, which thermal medium at normal pressure of 1000 mbar vaporizes at a temperature between 40° C. and 120° C. (in particular at a low temperature, for example between 40° C. and 60° C.). With a thermal medium which vaporizes at lower temperature, for example between 40° C. and 60° C. at normal pressure, the phase transition already occurs at comparatively lesser depth, for example from a depth of 1300 to 1400 m, in the coaxial tube.
Guide structures, for example spiral-shaped guide plates or barriers penetrated by nozzle openings, for example expansion plates, can be fixed, in particular welded on (comparable to a vertical pipe coil), to an outer wall of an inner tube of the coaxial tube down to the depth in which the phase transition occurs (phase transition threshold). With spiral-shaped guide plates, the steepness of the turns influences the time period until the thermal medium reaches the phase transition threshold. With barriers penetrated by nozzle openings, the opening cross sections of the nozzle openings and the distance between adjacent barriers influences this period, inter alia.
If guide plates are provided, a centrifugal force acts on the liquid thermal medium, so that the thermal medium is pressed against an inner side of the outer tube as it flows downward and friction heat thus results.
The inner tube can be thermally insulated in relation to the outer tube in order to prevent, or at least reduce, a heat transfer from the gaseous thermal medium guided in the inner tube to the liquid thermal medium flowing after in the outer tube. This insulation can be omitted in a lowermost section of the coaxial tube, for example in the lowermost 100 m, so that the thermal energy from the depth is transferred to the turns of the guide plates and these turns represent an additional heat transfer surface.
The liquid thermal medium reaches the phase transition threshold at the boiling temperature, which is available due to the geothermal energy at a specific bore depth.
The thermal medium becomes gaseous and seeks to rise upward, because of the lower density, in the outer tube. However, this is prevented because of the continuous addition of the liquid thermal medium and due to the turns of the guide plates.
New gaseous thermal medium arises continuously in the region of the end section due to the continuous addition of the liquid thermal medium into the outer tube. The gaseous thermal medium fills up the space between the region in which the phase transition threshold is located and a lowermost end of the coaxial tube in the outer tube and up to the blocking unit of the inner tube.
After a specific time period, which is controllable (for example via the filling quantity of the thermal medium), the pressure and the temperature rise in the coaxial tube. A technical aid, for example a compressor, which would minimize the economic expenditure, is not necessary for the temperature and pressure increase.
If a blocking unit of the coaxial tube is now opened, the gaseous thermal medium rises in the inner tube due to the chimney effect. The chimney effect results in this case due to a temperature difference between the temperature of the gaseous thermal medium in the end section of the coaxial tube and at the highest point of the inner tube in which the gaseous thermal medium flows. The gaseous thermal medium thus flows upward at a high velocity in the inner tube.
A widening of the pipe diameter of the inner tube at the upper end (the head) of the coaxial tube can be used for a higher temperature difference and thus an increase of the chimney effect. A thermal insulation which is not provided in an uppermost section, for example the uppermost 50 m, of the inner tube can also contribute in that the still cold liquid medium can contribute there to the cooling of the gaseous thermal medium flowing past there.
The high level of kinetic energy of the gaseous thermal medium is converted in a flow turbine (which can be similar to a wind turbine, for example) into rotational energy and is used to drive an electric generator. This turbine can be constructed smaller and more compactly due to the high kinetic energy of the gaseous thermal medium than would be possible and economically reasonable with a steam turbine or an updraft turbine.
The thermal energy in the gaseous thermal medium can additionally be used by means of heat exchangers for the heat supply or as production heat.
The geothermal thermal energy is only used in this novel method as a trigger of a phase change of a thermal medium.
The high level of kinetic energy of the gaseous thermal medium, which results due to the friction heat, the geothermal energy, the phase change with the vaporization heat, the temperature and pressure increase, and the chimney effect, is used for generating energy (electrical and/or thermal energy).
The novel method preferably takes place in a closed circuit, so that thermal medium does not have to be introduced into the earth and environmental endangerment or groundwater contamination also cannot occur.
If a thermal medium having a low boiling point is used, low thermal temperatures, corresponding to the low boiling point of the thermal medium, are already sufficient, which are not directly usable for thermal energy supply or for electrical energy production using known geothermal methods.
The density of the thermal medium and the height difference between the lowest point of the coaxial tube and the highest point of the pipeline in which the gaseous thermal medium flows also have significant influence.
A selectable low boiling point of the thermal medium results at lesser bore depths.
The use of the method is thus of great interest economically in very many regions, in which previously geothermal energy was not cost-effective due to the required bore depths.
By way of the implementation of the novel method, it is possible, for example using the electric energy thus obtained to operate electric charging stations on land and at sea for trucks, buses, passenger vehicles, ships, excursion boats, and ferries and thus provide a significant contribution to reducing the CO₂ emission.
The locations are selectable very flexibly, since the method according to the invention does not place any special location requirements, such as the presence of thermal sources, water-conducting or water-permeable layers/rocks, or high temperatures at low depths.

### LIST OF REFERENCE NUMERALS

1 coaxial tube
2 outer tube
3 inner tube
4 end section
5 guide plate
6 widening
7 degassing and storage container
8 thermal medium
9 line
10 pump
11 inlet
12 valve
13 line
14 flow generator
15 flow turbine
16 generator
17 valve
18 line
19 heat exchanger
20 line
21 short-circuit line
22 short-circuit line
23 installation building
25 expansion plate
26 passage nozzle
27 arrow
28 diffuser
29 diffuser
30 controller
31 transformer
32 control station
33 district/local heat supply

1. A method for obtaining useful energy from geothermal heat, comprising:
introducing a coaxial tube into a deep bore in the earth, wherein the coaxial tube includes an outer tube, in which the outer tube and the inner tube have a connection to one another in an end section of the coaxial tube sunk in the deep bore;
introducing a thermal medium liquid under standard conditions into the outer tube, which thermal medium flows in a direction of the end section of the coaxial tube sunk in the deep bore
heating the thermal medium while absorbing geothermal heat, wherein the thermal medium passes through a phase transition in a region of the end section and passes over in gaseous form into the inner tube and flows upward therein up to an upper end of the coaxial tube located at the Earth's surface; and
operating a flow generator for generating electric energy using the flowing, gaseous thermal medium.

2. The method as claimed in claim 1, further comprising:
guiding the thermal medium through a heat exchanger after flowing through the flow generator to obtain usable thermal energy.

3. The method as claimed in claim 2, further comprising:
liquefying the thermal medium after flowing through the flow generator; and
introducing the thermal medium in liquid form again into the outer tube of the coaxial tube.

4. The method as claimed in claim 1, further comprising:
guiding the thermal medium in the outer tube on a spiral-shaped path in the direction of the end section sunk in the deep bore.

5. The method as claimed in claim 1, further comprising:
accumulating the thermal medium in at least one section of the outer tube, due to barriers introduced into the outer tube;
transferring the thermal medium via nozzle openings which are formed in the barriers and lead into a vertically lower-lying section of the outer tube, with expansion into the vertically lower-lying section.

6. The method as claimed in claim 1, further comprising:
driving a deep bore into the earth and introducing the coaxial tube into the deep bore.

7. The method as claimed in claim 5, further comprising:
Introducing the deep bore into a depth of at least 1000 m.

8. The method as claimed in claim 5, further comprising:
introducing the deep bore to a depth of at most 2500 m.

9. The method as claimed in claim 1, further comprising:
using dodecafluoro-2-methylpentane-3-1 as the thermal medium.

10. A device for obtaining useful energy from geothermal heat comprising:
a coaxial tube introduced into a deep bore, wherein the coaxial tube includes an outer tube and an inner tube, and wherein outer tube and inner tube have a connection to one another in an end section of the coaxial tube sunk in the deep bore;
guide structures penetrated with nozzle openings, arranged in the outer tube and protruding through the outer tube's cross section;
a supply line connected to an inlet opening of the outer tube provided at an end of the coaxial tube axially opposite to the end section;
a gas flow channel connected to an outlet opening of the inner tube provided at the end section of the coaxial tube;
a flow generator arranged in the gas flow channel for generating electric energy; and
a thermal medium arranged to flow through the coaxial tube, wherein the thermal medium is liquid under standard conditions and has a boiling point at normal pressure of between 30° C. and 120° C.

11. The device as claimed in claim 10, wherein the thermal medium has a boiling point at normal pressure of between 30° C. and 60° C.

12. The device as claimed in claim 10, wherein a section of the inner tube arranged at the end section of the coaxial tube, in which section a diameter of the inner tube is widened starting from a first diameter, which the inner tube has along its extension up to an end section, up to a second diameter, and wherein the outlet opening is of the second diameter.

13. The device as claimed in claim 10, further comprising a flow guide, having a widening diameter, arranged after a flow turbine of the flow generator seen in the through-flow direction.

14. The device as claimed in claim 10, further comprising a heat exchanger which is arranged on a side of the flow generator opposite to the gas flow channel connecting the outlet opening to the flow generator and the heat exchanger is connected to the flow generator using a flow line for obtaining usable thermal energy.

15. The device as claimed in claim 10, wherein the outlet opening and the inlet opening are connected to one another in a closed line system.

16. The device as claimed in claim 15, further comprising a degassing and storage container arranged in the closed line system.

17. The device as claimed in claim 10, further comprising one or more valves in the supply line or the gas flow channel for deliberately opening or closing the supply line or the gas flow channel by a controller, which is connected to sensors for determining characteristic variables of the thermal medium located in the supply line or the gas flow channel, for automatically actuating the one or more valves.

18. The device as claimed in, claim 10 wherein the thermal medium is dodecafluoro-2-methylpentane-3-1.

19. The method as claimed in claim 5, wherein the accumulating of the thermal medium occurs in multiple sections of the outer tube due to plate-like barriers being introduced into the outer tube.

20. The device as claimed in claim 10, wherein the guide structures are spiral guide plates or plate-shaped barriers penetrated with nozzle openings
